(19) United States
(12) Patent Application Publication
(10) Pub. No.: US 2012/0101668 A1
(43) Pub. Date: Apr. 26, 2012

(54) APPARATUS, METHOD, AND PROGRAM FOR AUTOMATICALLY DISCRIMINATING SHIP

(76) Inventors: Atsushi IOROI, Nishinomiya-City (JP); Takayuki Yamasaki, Nishinomiya-City (JP)

(21) Appl. No.: 13/274,370

(22) Filed: Oct. 17, 2011

(30) Foreign Application Priority Data
Oct. 20, 2010 (JP) 2010-235119

(51) Int. Cl. G05D 1/02

(52) U.S. Cl. 701/21

(57) ABSTRACT

This disclosure provides an automatic ship discrimination apparatus, which includes a transceiver for transceiving ship information in a predetermined format, a storing module for storing the ship information received from a ship, and a data processor for processing transceived ship information data. The data processor refers to the ship information in the storing module, determines whether an item is missing from the ship information, and, if an item is missing, transmits a message for requesting the item.

### CROSS-REFERENCE TO RELATED APPLICATION(S)

The application claims priority under 35 U.S.C. §119 to Japanese Patent Application No. 2010-235119, which was filed on Oct. 20, 2010, the entire disclosure of which is hereby incorporated by reference.

### TECHNICAL FIELD

The present invention relates to an automatic ship discrimination apparatus for processing ship information transceived between ships and for automatically discriminating a ship.

### BACKGROUND OF THE INVENTION

Conventionally, as disclosed in JP2002-372583A, a universal shipborne automatic identification system (AIS) is used in view of, for example, preventing collision. The AIS transmits information of own ship to other ships, and once the other ships receive ship information, it is displayed on their display. The ship information includes information, such as, name and position information of the ship.

According to the AIS standard, there are different kinds of ship information: information that is automatically transmitted at a short time cycle such as ten seconds (e.g., position information), information that is transmitted at a long time cycle such as six minutes (e.g., a name of the ship), and information that is transmitted only manually (e.g., draft of a ship).

The ship information with short transmission cycle is promptly displayed, however the ship information with long transmission cycle remains not being displayed for a long time. Further, the information transmitted only manually is not transmitted as long as a user does not instruct to do so, therefore, causing a state where items of the ship information are missing for a long time.

### SUMMARY OF THE INVENTION

Thus, the present invention is made in view of the situations described above, and provides an automatic ship discrimination apparatus that can fill missing item(s) of the ship information.

According to an aspect of the invention, an automatic ship discrimination apparatus is provided, which includes a transceiver for transceiving ship information in a predetermined format, a storing module for storing the ship information received from a ship, and a data processor for processing transceived ship information data. The data processor refers to the ship information in the storing module, determines whether an item is missing from the ship information, and, if an item is missing, transmits a message for requesting the item.

Thereby, the request message is automatically transmitted and the missing item is automatically acquired.

Here, the data processor may transmit the request message only if among the missing item(s) an item needed by a user is missing from the ship information.

Note that, in the AIS, communication is performed using Time Division Multiple Access technology (TDMA) and an amount of information that can be transmitted within a predetermined time (the number of slots in every channel) is limited. Therefore, if the request message is frequently transmitted to a plurality of ships, all the slots will be occupied and the operation of the AIS may be affected.

The data processor may determine whether to transmit the request message based on information on a communication load.

In this case, the request message can be transmitted without stressing a communication line, and therefore, an automatic transmission can be achieved without affecting the operation of the AIS.

A load information describing the communication load, such as the number of messages received within a given time period and a Communication Status may be considered. The Communication Status is included in the ship information from other ship(s) and is used to grasp a status of use of the slots of each ship. By referring to this information, the existence of available slot(s) can be determined. When there are available slot(s) or when the number of available slots is more than a predetermined number, as the possibility of the AIS operation being affected by the transmission of a request message is low, the automatic transmission can be achieved.

The data processor may transmit request messages at random timings.

Because the transmission timings are random, a case where the same request messages are transmitted to a given ship at once can be prevented.

At this time, the data processor may preferably check if the item is still missing in the storing module before the timing of the request message transmission and determine whether to transmit the request message.

In the case where the transmission timings are random, in response to a first request message reception, a response message is broadcasted therefrom and, thereby, other ships can also receive the missing item of the ship information and do not need to transmit the request message. Therefore, the communication load can further be suppressed.

The data processor may preferably determine whether to transmit the request message based on at least one of a position, a speed and a navigation state of the ship.

If a ship close to own ship travels at fast speed, although the ship needs to be immediately contacted, if information such as ship's name is not available, the ship cannot be contacted. Therefore, depending on at least one of the position, the speed and the navigation state of other ships, if it is determined that missing item(s) needs to be immediately acquired, a request message is promptly transmitted.

According to the automatic ship discrimination apparatus of this invention, as the missing item(s) from the ship information is automatically acquired, the missing item(s) from the ship information can be filled.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a block diagram showing a configuration of an automatic ship discrimination apparatus;

FIG. 2 is a table showing other ships' data stored in a database 6;

FIG. 3 is a view explaining TDMA technology;

FIG. 4 is a view showing an example of a display view on a display 8;

FIG. 5 is a flowchart showing an operation of a data processor 5;

FIG. 6 is a flowchart showing an operation of the data processor 5;

FIGS. 7A & 7B are views explaining a situation where power goes from off to on when own ship is transmitting a request message automatically; and

FIGS. 8A & 8B are views explaining a situation where power goes from off to on when own ship is transmitting a request message at random timings.

### DETAILED DESCRIPTION

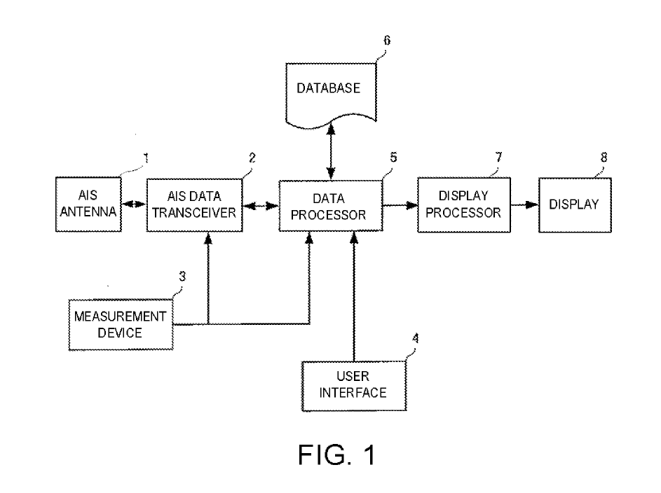

FIG. 1 is a block diagram showing a configuration of an automatic ship discrimination apparatus used in a ship automatic discriminating system (hereinafter, it may be referred to as the AIS). The automatic ship discrimination apparatus includes an AIS antenna 1, an AIS data transceiver 2, a measurement device 3, a user interface 4, a data processor 5, a database 6, a display processor 7, and a display 8.

The AIS antenna 1 receives signals transmitted from, for example, other ships and outputs them to the AIS data transceiver 2. The AIS data transceiver 2 receives ship information contained in the received signals. The data processor 5 stores the received ship information as other ships' data in the database 6.

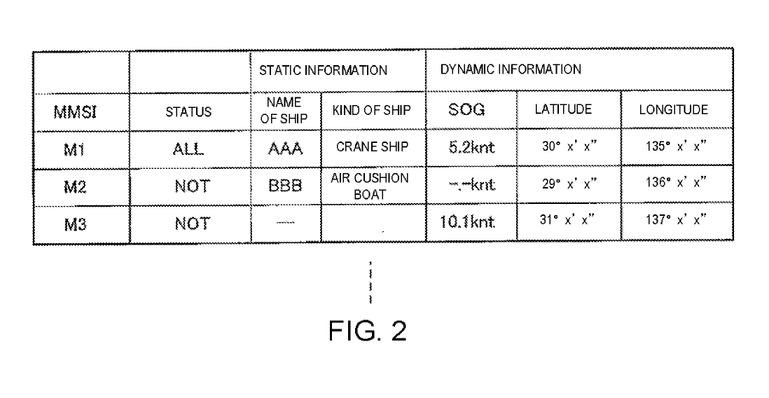

The ship information is constituted with dynamic information including items such as LAT/LON (latitude and longitude), SOG (ship's speed), COG (course over ground), HDG (heading), and Communication Status, static information including items such as ship name, discriminating code (MMSI), length and width of ship's body, and ship type, and navigation related information including items such as draft and destination arrival time. As shown in FIG. 2, the database 6 stores this information as the other ships' data for every ship. In FIG. 2, a ship with the status “ALL” indicates that all the above items are stored, and a ship with the status “NOT” indicates a state where missing items are present.

The measurement device 3 measures position and speed of own ship using, for example, a GPS. The data processor 5 extracts required data from the plurality of other ships' data stored in the database 6 and outputs the information indicating positions and speeds of other ships as well as the position and speed of own ship, as display data to be displayed on the display 8. The display processor 7 receives the display data inputted from the data processor 5, and uses the display data to display various kinds of information on the display 8. The user interface 4 is configured with, for example, a pointing device and a keyboard, and a display scale ratio and a display range on the display are set by a user operating the user interface 4.

The data processor 5 outputs the information inputted from the measurement device 3 and related to the position and the speed of own ship to the AIS data transceiver 2, as the ship information. The AIS data transceiver 2 transmits the ship information of own ship via the AIS antenna 1.

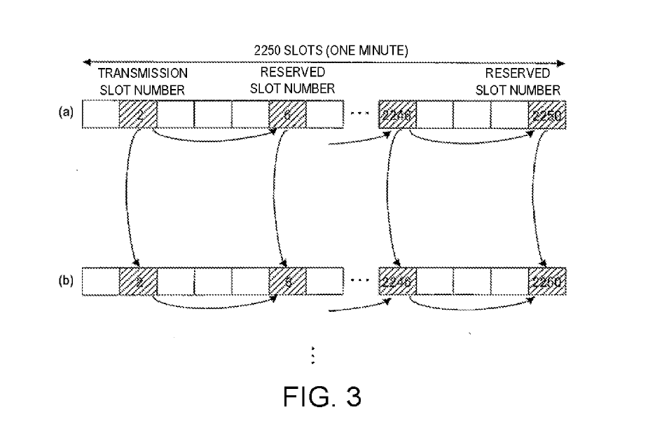

As shown in parts (a) and (b) of FIG. 3, in AISs, the ship information is transmitted using TDMA technology. In the TDMA technology, a predetermined time length (e.g., one minute) is divided into a predetermined number (e.g., 2250), and each ship occupies each divided time band (slot) and transmits its ship information. By referring to the Communication Status included in the ship information transmitted by other ships, the information that tells which ship occupies which slot can be determined. The Communication Status includes information such as the number of ship information received by each ship, the transmission slot number, the next transmission slot number (reserved slot number), the number of minutes a slot is continuously reserved. For example, as shown in part (a) of FIG. 3, a given ship occupies the second slot among the 2250 slots to transmit its ship information; in the Communication Status the given ship indicates that it will use slot 6 to transmit the next ship information and indicates it will continuously use the current slot (second slot) for two minutes. Hereupon, the given ship transmits again the ship information at slot 6 and indicates the next transmission slot number and the number of minutes the slot is reserved. Thus the ship information is repeatedly transmitted in this way and as shown in part (a) of FIG. 3, the ship information is also transmitted at slot 2246 and slot 2250. As shown in part (b) of FIG. 3, the ship information is transmitted from the given ship at the second slot which was previously reserved as shown in part (a) of FIG. 3, and the ship information is transmitted again from the given ship at the reserved slots 6, 2246, and 2250. The ship information is transmitted using Time Division Multiple Access technology.

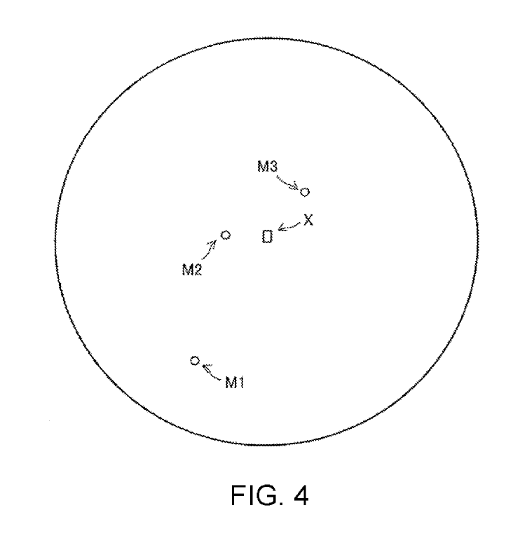

FIG. 4 is a view showing an example of a display view on the display 8. Here, the circled area, delimiting a predetermined area, indicates the range from which ship information can be retrieved (note that, it is merely an explanatory example of the display view, and not an actual AIS display screen). In the view, own ship X is displayed with a rectangular mark. This rectangular mark indicates the position of own ship. Other ships are represented with a circle mark. The displayed position of the circle marks indicates the position of every other ship. Although it is omitted in FIG. 4, information on, for example, name and type of each ship is displayed near the other ships' mark.

As above, the information on each ship is transceived, and thereby, a user on each ship can grasp, for example, names, positions and speeds of other ships.

Here, according to the AIS standard, the dynamic information described above is transmitted at comparatively short time intervals (e.g., two seconds, six seconds, ten seconds, thirty seconds or 3 minutes) and, on the other hand, the static information is transmitted at a fixed cycle of six minutes. Therefore, the items of the static information will not be stored in the database 6 until six minutes later at maximum. In addition, ship information may not be able to surely be received every time because of, for example, a transmission error, therefore, the static information items may not be stored even for a longer time. In this case, the name and the MMSI of each ship are not displayed for a long time, which can be inconvenient when other ships need to be contacted. Further, also navigation related information is not transmitted as long as the user does not instruct to do so manually, which causes similar inconvenience.

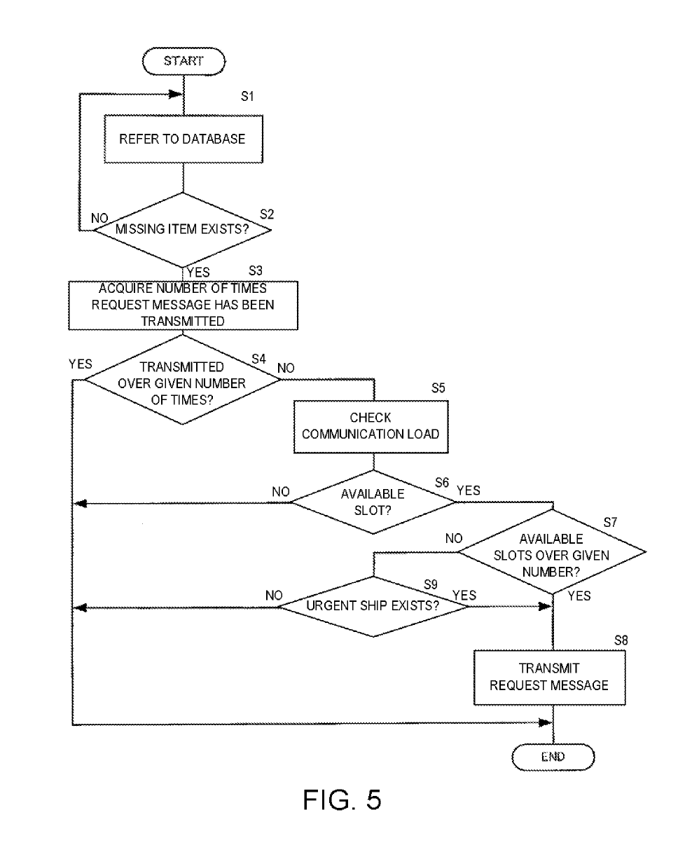

Thus, the data processor 5 of this embodiment automatically acquires missing item(s) in the ship information. That is, the data processor 5 performs operations shown in a flowchart in FIG. 5. These operations are executed regularly (e.g., every time the data processor 5 receives the dynamic information).

First, the data processor 5 refers to the other ships' data stored in the database 6 (S1), and determines whether an item is missing (S2). That is, the data processor 5 checks the status of each ship and checks if a status “NOT” exists. If the status “NOT” exists, the data processor 5 determines that an item is missing and transmits a message for requesting the item(s) to the corresponding other ship. Note that for the purpose of this example, the status “NOT” is activated because an item specified by the user is missing, however the status “NOT” will be activated for any missing item.

Here, when an item is missing, the request message may immediately be transmitted; however, the number of slots for every channel in the AIS is limited as described above. Therefore, if such a request message is transmitted frequently to a plurality of other ships, all the slots will be occupied and the AIS may be affected in its operation. Thus, the data processor 5 determines whether to transmit the request message according to, for example, a communication load, as follows.

First, the data processor 5 determines whether the same request message has been previously transmitted to the other ships (S3). If the request message has already been transmitted over a given number of times (e.g., five times), the data processor 5 determines that this other ship is in a state of not being able to respond because of, for example, being under a reception dedicated mode or a failure, and aborts the operation.

On the other hand, if the number of transmission of the request message is below the given number, the data processor 5 checks the communication load (S5). The communication load can be determined from, for example, the number of other ships receiving own ship information, the number of messages received within a given time period, the transmission frequency of dynamic information, and the Communication Status. The communication load can be considered as being increasing as the number of other ships receiving own ship information is increasing or as the number of received messages is increasing. Moreover the transmission frequency of dynamic information is changing depending on the ship speed (SOG) of every ship, for example, every two seconds, or every six seconds, or every ten seconds, or every 30 seconds, or every three minutes. Therefore, the transmission frequency of other ships can be determined with reference to the SOG included in the received dynamic information. If the transmission time cycle is short, it means that messages are frequently transmitted from other ships and therefore, the communication load can be determined to be high.

The data processor 5 refers to these pieces of information as load information, and if it determines that the communication load is high, the operation may be aborted without transmitting the request message; however, as described below, a determination of the communication load can be performed further suitably for the MS by referring to the Communication Status, included in the dynamic information, as the load information.

That is, the data processor 5 refers to the Communication Status to determine whether a slot is available (S6). If all the slots are occupied, then the message cannot further be transmitted, and therefore, the data processor 5 aborts the operation.

On the other hand, if there are available slots, the data processor 5 checks if the number of available slots is above a given number (e.g., ten slots) (S7). If this is the case, the data processor 5 transmits the request message to the ships from which an item(s) is missing (S8). The ship that has received the request message then transmits a response message to the received request message. The request message may be a message requesting to transmit only the missing item(s), or may be a message requesting to transmit all the items. The response message to the request message is transmitted in a broadcast way (which is also the transmission way used when transmitting dynamic and static information).

Alternatively, if the data processor 5 determines that the number of available slots is below the given number, because the operation of the AIS may be affected, it performs the check shown at S9. For example, when a plurality of ships move into a receivable range of own ship at the same time, each of the other ships ignores whether the slot is reserved and transmits a message, thereby, it is highly possible that these messages collide with the message of own ship.

At S9, the data processor 5 determines whether it is necessary to urgently receive ship information from other ships. For example, if a ship is close to own ship or travels at fast speed, because immediate contact is necessary, the data processor 5 determines that it is necessary to urgently receive the ship information from the other ship. Alternatively, the data processor 5 may determine whether it is necessary to urgently receive the ship information by referring for example to the NAV STATUS navigation state (information indicating, for example, mooring or moving status) or the BLUE SIGN navigation state (binary data information used to notify other ships when a ship is reversing in a canal).

If the data processor 5 determines that it is necessary to urgently receive the ship information, it transmits the request message even if the number of available slots is below the given number (S8).

Thus, the request message can be transmitted without affecting the operation of the AIS and the missing item(s) can automatically be acquired.

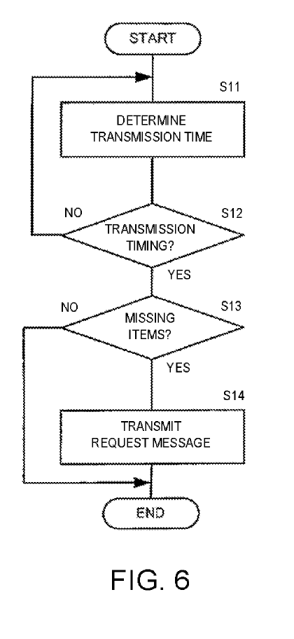

Further, the data processor 5 may automatically acquire the missing item(s) of the ship information using the operation shown in FIG. 6.

That is, the data processor 5 determines the transmission time of request messages so that request messages are transmitted at random time (S11). For example, after the decision at S8 in FIG. 5, the data processor 5 adds an arbitrary random time to determine the transmission timing. Then, when the data processor 5 determines that the transmission timing has come (S12), it refers to the database 6 again, and checks if an item(s) is missing (S13). Here, the data processor 5 aborts the operation if there is no missing item, or the data processor 5 transmits the request message if there is a missing item(s) (S14).

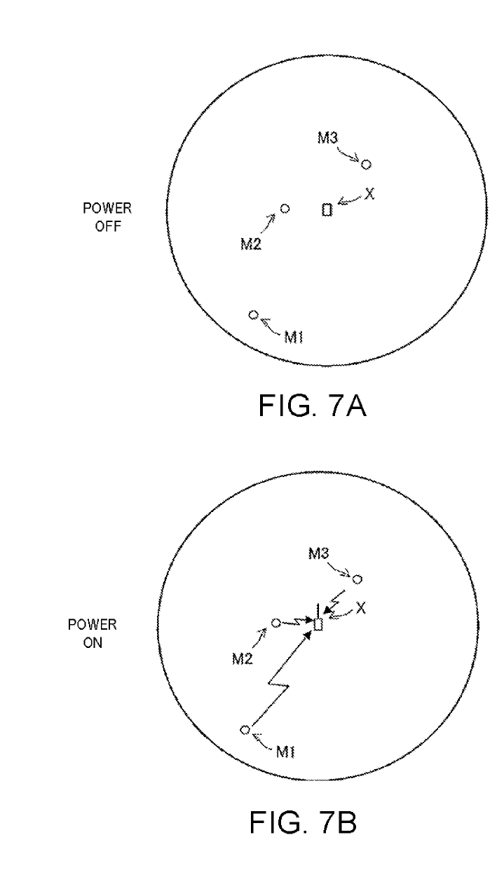

As above, by distributing the transmission time at random, the same request messages are not transmitted at once to a given ship. For example, as shown in FIG. 7A, in a situation where a plurality of other ships exist around own ship and the power of the AIS is off, and then as shown in FIG. 7B, if the power is turned on, as the possibility that the other ships cannot receive the static information of own ship is high, request messages are transmitted from other ships to own ship at once. However, by separating the transmission timings at random as described above, such a case where the same request messages are transmitted at once is prevented.

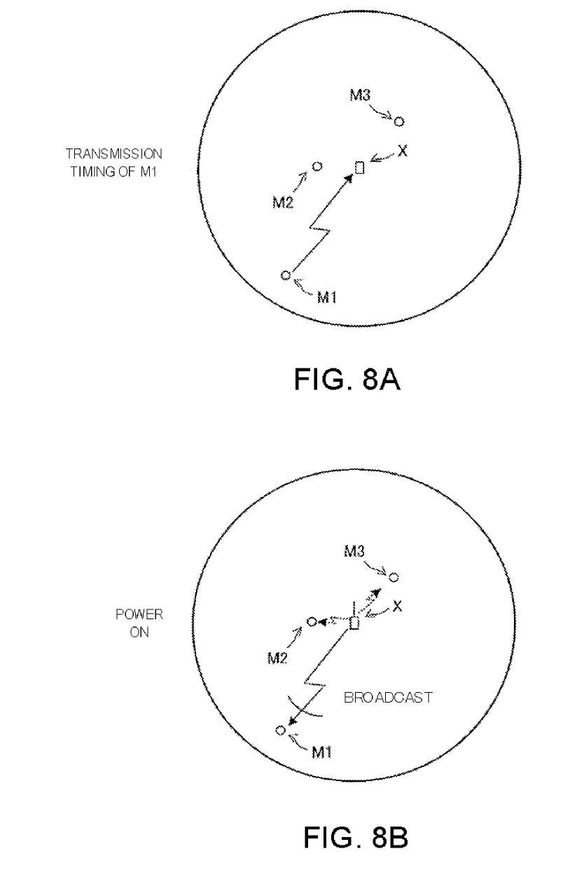

Further, before transmitting a request message, the data processor 5 checks again if the missing item(s) is still missing in the database 6 in order to determine if the request message still needs to be transmitted, therefore the communication load can further be suppressed. That is, as shown in FIG. 8A, when a ship M1 first transmits a request message, as shown in FIG. 8B a response message corresponding to the request message is transmitted in a broadcast way, and thereby, other ships M2 and M3 can also receive the missing item(s) of the ship information and another transmission of a request message is no longer required. Therefore, the communication load can further be suppressed.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. An automatic ship discrimination apparatus, comprising:
a transceiver for transceiving ship information in a predetermined format;
a storing module for storing the ship information received from another ship; and
a data processor for processing transceived ship information data, wherein the data processor refers to the ship information of the other ship in the storing module, determines whether an item is missing from the ship information, and, if an item is missing, transmits a request message for requesting the item.

2. The apparatus of claim 1, wherein if among the ship information data of other ship an item needed by a user is missing, the data processor transmits the request message.

3. The apparatus of claim 1, wherein the data processor determines whether to transmit the request message based on information on a communication load.

4. The apparatus of claim 3, wherein the ship information is transmitted using Time Division Multiple Access technology; and
wherein the communication load information is an information included in the ship information and related to slots for the Time Division Multiple Access.

5. The apparatus of claim 1, wherein the data processor transmits the request message at random timings.

6. The apparatus of claim 5, wherein the data processor checks if the item is still missing in the storing module before the timing of the request message transmission and determines whether to transmit the request message.

7. The apparatus of claim 1, wherein the data processor determines whether to transmit the request message based on at least one of a position, a speed and a navigation state of the other ship.

8. A method of automatically discriminating a ship, comprising:
transceiving ship information in a predetermined format;
storing the ship information received from another ship; and
processing transceived ship information data, the processing step including referring to the stored ship information of other ship, determining whether an item is missing from the ship information, and, if an item is missing, transmitting a request message for requesting the item.

9. An automatic ship discriminating program for causing an automatic ship discrimination apparatus to:
transceive ship information in a predetermined format;
store the ship information received from another ship; and
process transceived ship information data, the processing of transceived data including referring to the stored ship information of other ship, determining whether an item is missing from the ship information, and, if an item is missing, transmitting a message for requesting the item.
